(19) United States
(12) Patent Application Publication
(10) Pub. No.: US 2022/0309467 A1
(43) Pub. Date: Sep. 29, 2022

(54) APPLICATION PROGRAMMING INTERFACE (API) FOR A SYSTEM FOR DETERMINING SUITABILITY OF AN APPLICANT FOR A ROLE IN A COMPANY

(71) Applicant: O5 Systems Inc., Toronto (CA)

(72) Inventors: Paul Michael Inder, Toronto (CA); Lena Shulamit Umansky, Toronto (CA); Marc Chretien Jeanneret, Toronto (CA); Eduardo Ito, Toronto (CA); Matthew Sergeant, East York (CA); David Jorjani, Toronto (CA); Nemanja Stefanovic, Toronto (CA); Shaun Christopher Ricci, Toronto (CA); Somen Mondal, Toronto (CA)

(21) Appl. No.: 17/210,341

(22) Filed: Mar. 23, 2021

(51) Int. Cl. G06Q 10/10; G06N 20/00; G06F 9/54

(52) U.S. Cl. CPC G06Q 10/1053; G06N 20/00; G06F 9/54

(57) ABSTRACT

A scalable software application or platform for interfacing an organization or partner comprising multiple entities or business units to a job screening system for generating a grade or score for a candidate or job applicant for one or more of the entities. According to an embodiment, the software application comprises an Application Programming Interface (API) configured to interface an organization or a partner, for instance, a whitelist customer, comprising a plurality of entities or business units to a job screening system. According to an embodiment, the Application Programming Interface comprises a companies API endpoint, a jobs API endpoint, an applications API endpoint and an authentication API endpoint. The API is configured to provide an organization or partner level integration level with the job screening system for the companies or entities associated with the organization or partner.

### FIELD OF THE INVENTION

The present invention relates to computer systems and more particularly, to a system and method for determining suitability of a candidate for a role in a company and comprising a scalable application programming interface (API) or platform for an organization or partner comprising multiple entities or business units.

### BACKGROUND OF THE INVENTION

Organizations such as corporations may comprise multiple business entities, such as, subsidiaries, business units, related companies, and the like. Each business entity will have jobs or positions, and some or all of those jobs may, in turn, be company specific. Job recommendation systems and/or job screening systems, such as the job recommendation system from Ideal (OS Systems Inc.) provides a state of art of computer and Al based system for processing job applications and generating job recommendations for a company.

For organizations such as corporations or partner companies with multiple companies, it is desirable to have a single or integrated platform configured to manage and control job applications and provide job screening and/or hiring recommendations utilizing a job recommendation or screening system such as the system from Ideal.

It will therefore be appreciated that there remains a need for improvements in the art.

### BRIEF SUMMARY OF THE INVENTION

The present invention is directed to a scalable software application or platform for interfacing an organization or a partner company comprising multiple entities or business units to a system and/or a process for screening applications for one or more jobs for a candidate or job applicant for one or more of the entities.

A computer system, a computer program product and a computer-implemented method is provided for performing screening of job applications for one or more candidates or applicants for an organization comprising one or more entities, operating businesses, clients, customers or the like. According to an exemplary embodiment, the system comprises a software module configured for interfacing an organization with a computer system configured for performing or executing screening of applications for a job for one or more candidates or applicants. According to an exemplary implementation, the software module comprises an Application Programming Interface (API) which is configured to interface the organization, and one or more companies, entities, clients, business units, customers or operating units associated with the organization, with the computer system configured for executing job screening. The software module is configured to provide the capability for one or more of the entities associated with the organization to access the job screening system independently.

According to an embodiment, the present invention comprises a software module configured for providing an interface to a job screening system, said job screening system including a server configured with a database and a machine learning engine configured for screening one or more applications for a job or position at a company, said software module comprising: a software component configured for updating data associated with the company, said database comprising a record for the company and including one or more data fields for storing said associated company data; a software component configured for updating data associated with the job, said database comprising a record for the job and including one or more data fields for storing said associated job data; a software component configured for updating data associated with the one or more applications, said database comprising a record for each of the one or more applications and including one or more data fields for storing said associated application data; the machine learning engine comprising a processor component configured to screen the application based on said application record and based on said screening process generate a score for the application; and said applications software component being configured to make available said generated score to the company.

According to another embodiment, the present invention comprises a computer-implemented process for accessing a job screening system through an application programming interface (API), said computer-implemented process comprising the steps of: submitting an application for a candidate for grading through an application endpoint to the API for the job screening system; screening the application at the job screening system utilizing a machine learning model and generating a grade for the application; updating an application record for the candidate in a database for the job screening system; and providing said grade through said application endpoint to the API.

According to another embodiment, the present invention comprises a computer program product for providing an interface to a job screening system, said job screening system including a server configured with a database and a machine learning engine configured for screening one or more applications for a job or position at a company, said computer program product comprising: a non-transitory storage medium configured to store computer readable instructions; said computer readable instructions including instructions for, updating data associated with the company through a company endpoint to an application programming interface (API), said database comprising a record for the company and including one or more data fields for storing said associated company data; updating data associated with the job through a job endpoint to an API, said database comprising a record for the job and including one or more data fields for storing said associated job data; updating data associated with the one or more applications through an applications endpoint to the API, said database comprising a record for each of the one or more applications and including one or more data fields for storing said associated application data; and screening the application utilizing a machine learning engine in the job screening system and generating a grade for the application.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary network-based configuration suitable for implementing a system and a method comprising an Application Programming Interface or API interface according to embodiments of the present invention;

FIG. 2 shows in diagrammatic form an exemplary workflow or process for the API according to an embodiment of the present invention;

FIG. 3 shows in diagrammatic form an authorization function (form or window) for the API interface according to an embodiment of the present invention;

FIG. 4 shows in diagrammatic form a companies' function (form or window) for the API interface according to an embodiment of the present invention

FIG. 5 shows in diagrammatic form a jobs function (form or window) for the API interface according to an embodiment of the present invention;

FIG. 6 shows in diagrammatic form an applications function (form or window) for the API interface according to an embodiment of the present invention;

FIG. 7A shows in diagrammatic form a schema or database structure for configuring a “Company” for the API interface according to an embodiment of the present invention;

FIG. 7B shows in diagrammatic form a schema for configuring a “Job” for the API interface according to an embodiment of the present invention;

FIG. 7C shows in diagrammatic form a schema for configuring an “Application” for the API interface according to an embodiment of the present invention;

FIG. 7D shows in diagrammatic form a schema for configuring an “Error Response” for the API interface according to an embodiment of the present invention; and

FIG. 8 shows in block diagram form an exemplary implementation of a system according to an embodiment of the present invention.

Like reference numerals indicate like or corresponding elements or components in the drawings.

### DETAILED DESCRIPTION OF THE EMBODIMENTS OF THE INVENTION

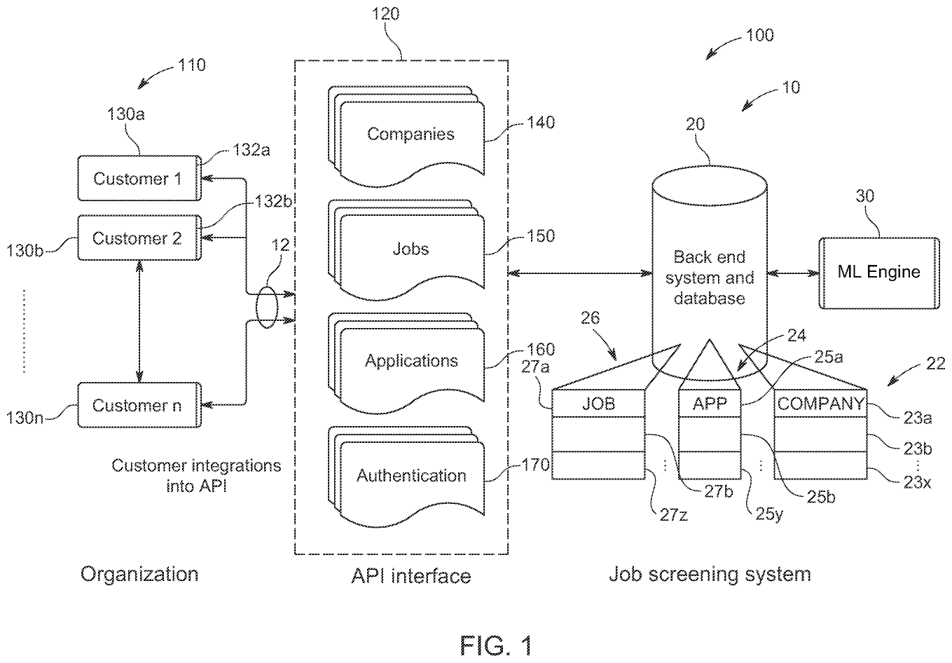

Reference is first made to FIG. 1, which shows an exemplary network-based implementation of a system for generating a score, a report card, and/or a recommendation for one or more candidates associated with, or in, an organization, for instance, an employment position or other job function, and indicated generally by reference 100. The system 100 comprises a job or candidate screening system indicated generally by reference 10 and a computer system or computer platform for an organization or company indicated generally by reference 110. The organization computer system or processing platform 110 is operatively coupled to the job screening system 10 through a network, for example, the Internet, indicated generally by reference 12. The job screening system 10 comprises a server (or one or more servers) indicated generally by reference 20 configured with a job screening processor and a database, and a machine learning (ML) engine or module (i.e. a job screening engine) indicated generally by reference 30. According to an exemplary embodiment, the job screening system 10 comprises a job screening and/or recommendation system based on a system or implementation as described in U.S. Patent Application Publication No. 2020/0184422 published on Jun. 11, 2020, U.S. Patent Application Publication No. 2020/0184425 published on Jun. 11, 2020, and/or U.S. patent application Ser. No. 17/112,823 filed Dec. 4, 2020, each of which is incorporated in its entirety herein by reference.

According to an exemplary embodiment, a job screening system is configured to perform or execute screening operations comprising screening the applications of multiple candidates for a job being offered by an organization, a partner company (e.g. a “whitelist company” that manages customers, e.g. “companies”) or a client, or other business entity. For example, a job opening can receive thousands of applications from potential applicants or job seekers. According to an exemplary embodiment and as will be described in more detail below, the job screening system 10 comprises a screening engine configured to process, i.e. screen, each application and compare with a Machine Learning Model (for instance, a ML Model generated utilizing the ML Engine) and generate or assign a grade to the application.

According to another embodiment, the job screening system further comprises a job recommendation system. The job recommendation system is configured to process the application of a candidate or job seeker applying to an organization or business entity. According to an exemplary embodiment, the job recommendation system is configured to generate one or more job recommendations for the applicant available at the organization or business entity. The job screening system is configured to screen the applicant or job seeker for one or more the recommended jobs, and generate, for example, a grade or a report card for the applicant.

As shown in FIG. 1, the organization or partner company computer platform 110 interfaces to the job screening system 10 through a software module or component 120 configured to interface with the job screening system 10. According to an exemplary embodiment, the software module or software component 120 comprises an Application Programming Interface (API) which is configured to interface with the job screening system 10 through the network 12, i.e. the Internet. As also shown in FIG. 1, the organization computer system or platform 110 comprises one or more units (i.e. clients machines, computers or computer systems, or processing appliances) indicated generally by reference 130, and individually by references 130a, 130b . . . 130n. The units 130 comprise client machines, computers, computer systems or processing appliances for companies, subsidiaries, business units, business entities, client companies, associated companies, clients, customers, and the like, associated with the organization.

The client machine or computer or appliance 130 may include a device, such as a personal computer, a wireless communication device or smart phone, a portable digital device such as an iPad or tablet, a laptop or notebook computer, or another type of computation or communication device or appliance, a thread or process running on one of those devices, and/or an object executable by one of these devices.

The network 12 may comprise a local area network (LAN), a wide area network (WAN), a telecommunication network, such as the Public Switched Telephone Network (PSTN), an Intranet, the Internet, or a combination of networks. According to another aspect, the system 100 may be implemented as a cloud-based system or service utilizing the Internet 12.

The API 120 is configured to allow the organization or partner company platform 110 to access selected API endpoints in the job screening system 10 and push data (and get data) into the job screening system 10 for analysis, processing and/or grading or screening, as will be described in more detail below.

According to an embodiment, the API 120 comprises a “companies” module or component (i.e. endpoint) indicated by reference 140, a “jobs” module or component (i.e. endpoint) indicated by reference 150, an “applications” module or component (i.e. endpoint) indicated by reference 160 and an “authentication” module or component (i.e. endpoint) indicated by reference 170.

As will be described in more detail, the API 120 provides the capability for the organization computer system 110 and the computers 130 for the entities, e.g. business units, to interface (e.g. via the selected endpoints) to the job screening system 10 independently of the implementation or architectural details of the job screening system 10.

According to an exemplary embodiment, the API 120 comprises a software module or component configured to receive REST (Representational State Trainer) calls into each endpoint of the Application Programming Interface (API) 120 for access to the job screening system 10. The API 120 is configured to authenticate integration for access by the organization or partner company platform 110 (and the customer or client machines 130) to the API 120 for the job screening system 10. The units 130, e.g. business units or clients, comprising the organization 110 are provided access to the job screening system 10 through the API 120, and the functionality and associated capabilities of the job screening system 10 appear native through the API 120.

According to an exemplary implementation, one or more of the client machines for the entities 130 are configured with a software module or component 132, indicated individually by references 132a, 132b . . . 132n. According to an embodiment, the software module 132 comprises an interface, for example, implemented as a graphical user interface or GUI, configured to connect or interface with the Application Programming Interface or API 120 for accessing the functionality and capabilities as described in more detail below.

According to an embodiment, the job screening system 10 and the API 120 are configured to manage the clients or business units 130 comprising the organization as logically separate entities. According to an exemplary implementation, the job screening system 10 comprises “buckets”, i.e. logically separated entities, configured to manage and control the selected job recommendation functionality or capabilities, e.g. live screening, filter internal candidates, etc., available or provided by the job screening system 10. For instance, each bucket in the job screening system 10 comprises data and operations associated with each job or position, candidate, application, associated with unit or entity 130. The bucket may also be configured as a control mechanism to regulate or control the use of the job screening system 10, and/or its resources, by the organization or company. It will be appreciated that this hierarchical or segregated configuration provides the functionality/capability to process an organization with multiple units, entities, or companies, for instance, a “whitelist” customer, on one server configured with each of the entities (including the jobs, applications, candidates, associated with the entity), and each entity have its own virtual access to the job screening system 10 through the API 120.

According to an exemplary embodiment, the Authentication module 170 is configured to manage authentication, e.g. credentialed access, at the organizational level. An API token is provisioned for the organization or partner integration. The API token is configured with a role and a set of permissions defining the level of access for the organization or partner to each endpoint in the job screening system 10.

According to an embodiment, the API 120 is configured to provide each entity, e.g. business unit or customer computer system, 130 with independent access to the job screening system 10. According to an embodiment, the API 120 is configured to provide an organization level integration for all the entities comprising or associated with the organization as described in more detail below. This allows all the associated entities to communicate and interact with the job screening system 10 based on one integration. As shown, the companies module 140 comprises an endpoint in the API 120 which is configured to receive customer data, i.e. entity data, associated with the customer entity 130 for the job screening system 10. The job screening system 10 is configured to generate a new or corresponding company or customer entity 22 in the database 20, or update an existing company or customer entity 22 in the database, indicated individually by references 23a, 23b . . . 23x in FIG. 1. According to an embodiment, the customer entities 23a, 23b . . . 23x are logically separated in the job screening system 10. According to another aspect, the database 20 comprises a hierarchical configuration for associating jobs, candidates and/or job applications for each customer 130, i.e. entity, as will be described in more detail below.

The jobs module or component (i.e. endpoint) 150 in the API 120 is configured to input or receive jobs data for jobs that are created, or jobs that are modified, by customers 130 on the organization platform 110. The jobs module 150 comprises an endpoint in the API 120 which is configured to input or receive jobs data for the associated customer entity 130 in the job screening system 10 and stored in the database 20. According to another aspect, the job screening system 10 is configured to group or organize the new jobs or the modified jobs into groupings comprising “roles” or buckets. According to another aspect, the jobs roles or buckets can be defined at a customer or entity level. According to another aspect, the jobs roles or buckets can be defined at an organization level. The machine learning (ML) engine 30 in the job screening system 10 is configured to process each job grouping or jobs bucket utilizing an associated ML model in the ML engine 30. According to an exemplary implementation, the job screening system 10 is configured to determine the job groupings or buckets, for example, as an automated operation or processing step.

The applications module or endpoint 160 in the API 120 is configured to input job applications data for job applications that are created, or job applications that are modified, by customers 130 on the organization platform 110. The application module 160 comprises an endpoint in the API 120 which is configured to input or receive applications (e.g. job applications) data for the associated customer entity 130 in the job screening system 10. The job screening system 10 is configured to update the applications data and store the data in the database 20. According to another aspect, the job screening system 10 is configured to run the ML engine 30, i.e. a ML screening engine, to produce a grade or score for the associated job role. The job application is graded or score (i.e. in time), and the application data, e.g. the score or grade, is stored in an application record 24 in the database 20 and retrievable by the customer 130 via the API 120. According to another aspect, each subsequent update or modification on job application is applied or propagated to the application record, and utilized to further train the ML model in the ML engine 30. According to another aspect, the application record 24 (indicated individually by references 25a, 25b . . . 25y In FIG. 1) further comprises information or details about a job applicant including employment history, education history and/or details on the job or role in the client or customer 130. According to another aspect, the application data can be utilized to generate or construct a job's summary or report, e.g. a report card, or an applicant's report card, on the organization or partner platform 110. According to an exemplary implementation, the application data and jobs data are stored in a structured open standard file format or data interchange format, such as JavaScript Object Notation (JSON), in order to facilitate parsing by the organization or partner platform 110. According to an embodiment, the job screening system 10 generates a report card in JSON format and comprising the grades generated by the screening system 10, extracted skills, job history, and/or selected personal data, and other associated data elements. The JSON form report card provides a convenient format for the organization (e.g. partner company) to create or generate their own report card, i.e. a visual representation, tailored or according to the particular implementation of their platform.

In operation, the organization or partner API 120 is configured to provision multiple customers or clients (i.e. entities 130) comprising the organization or partner on the organization or partner platform 110 with access to the job screening system 10 through selected or defined API endpoints. The organization or partner platform 110 is configured to manage or control the information and data that is sent or transmitted to the job screening system 10 for the purposes of screening the job applicants and/or generating application data. The database 20 and the ML engine 30 for the job screening system 10 is hidden behind the API layer 120.

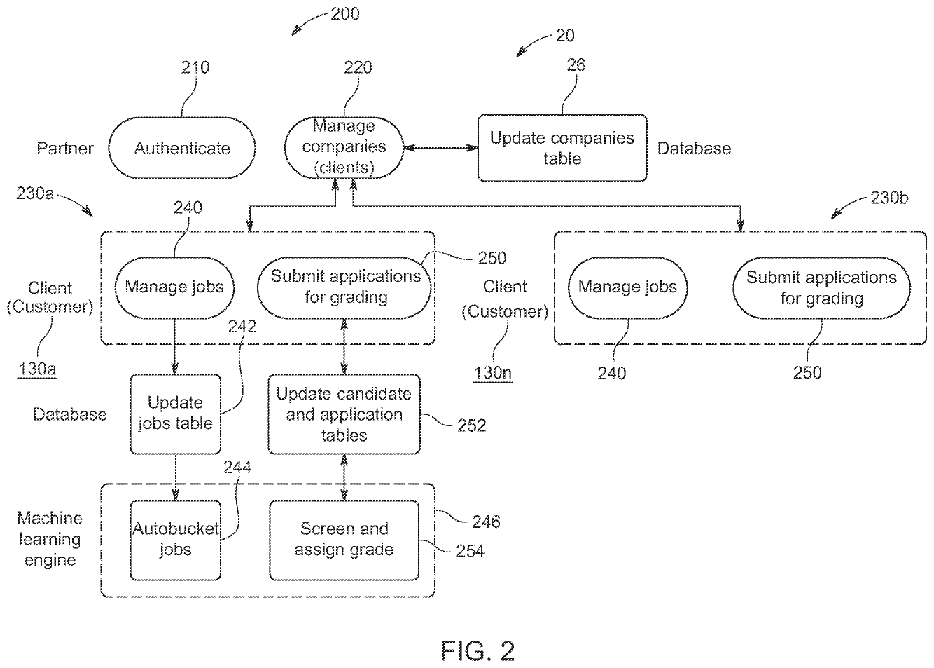

Reference is next made to FIG. 2, which shows in diagrammatic form an exemplary workflow or process for the Application Programming Interface (API) 120 according to an embodiment of the present invention, and indicated generally by reference 200.

As shown in FIG. 2, the API 120 is configured to control and manage authentication of the entities, e.g. companies, clients or customers 130 in FIG. 1, at the partner or organizational level, according to an embodiment and indicated by reference 210. According to an embodiment, the API 120 is configured to manage the entities, e.g. companies, clients or customers 130, at the partner or organizational level, as indicated by reference 220. According to an exemplary embodiment, for a new client 130, for example, a new client for the organization 110 or a new request from an existing client or customer, the API 120 is configured to register the new client with the job screening system 10. The registration process comprises updating a Companies Table 22 in the database 20 in the job screening system 10 (FIG. 1).

The API 120 is configured to interface the job screening system 10 and manage job(s) and job application(s) for each entity, e.g. client or customer 130, as described above. The API 120 is configured to manage and control the workflow between each client or customer machine 130, i.e. entity, and the job screening system 10 as indicated generally by reference 230 in FIG. 2. The workflow 230a for the client or customer 130a comprises two main functions or processes: managing jobs as indicated by reference 240 and submitting applications as indicated by reference 250.

The managing jobs process 240 comprises sending or transmitting each job for the client or customer 130a to the job screening system 10 through the API 120 (for example, the jobs endpoint 150 in the API 120 in FIG. 1). A jobs table 26 in the database 20 in the job screening system 10 is updated as indicated by reference 242 in FIG. 2. According to an exemplary embodiment, the jobs table 26 comprises a jobs record(s) 27 for each client or customer 130 indicated individually by references 27a, 27b . . . 27z in FIG. 1. According to an exemplary implementation, the job screening system 10 is configured to “autobucket” jobs, i.e. group or segregate the new jobs (or modified jobs) into “buckets,” as indicated by reference 244. The autobucketing step or operation 244 comprises grouping the jobs into buckets via roles and updating the associated job record 27 in the jobs table 26. The job screening system 10 is configured to process each job grouping or job bucket utilizing an associated ML model in the ML engine 30 (FIG. 1) as indicated by reference 246 in FIG. 2. The job record(s) 27 is associated with the appropriate client or customer 22 and logically separated in the database 20, as described above for example.

The application process 250 comprises submitting applications through the jobs endpoint 150 in API 120 to the job screening system 10 to generate a grade and/or a report card according the screening process. The job screening system 10 is configured to utilize the jobs data to update the application record 25a for the associated client 130a in the applications table 24, and the candidate data in the customer entity record 22a in the database 10 (FIG. 1), as indicated by reference in FIG. 2. The job screening system 10 is configured to process the application and generate a grading utilizing an associated ML model in the ML engine 30 (FIG. 1) as indicated by reference 254 in FIG. 2. The customer entity record 22a is updated and logically separated in the database 20, as described above.

In summary and according to an exemplary embodiment, the API 120 allows the organization or partner platform 110 to interface with the job screening system 10 and access and manage jobs and/or applications for each client or customer 130. The organization or platform 110 manages and/or controls authentication and access to the job screening system through the API 120. According to an exemplary implementation, the partner platform 110 is configured to make calls into the job screening system 10 through the API 120. In the job screening system 10, the database 10 is configured to logically separate each client or customer entity and the associated data in a database 20 configured with a hierarchical database structure. According to another aspect, new jobs or roles are grouped into job buckets or job clusters, and the job buckets are utilized for creating or generating an associated, e.g. dedicated, ML model in the ML engine 30.

It will be appreciated that one or more embodiments according to the present invention provide a highly scalable and flexible architecture or platform for an organization or company comprising multiple entities such as subsidiaries or business units.

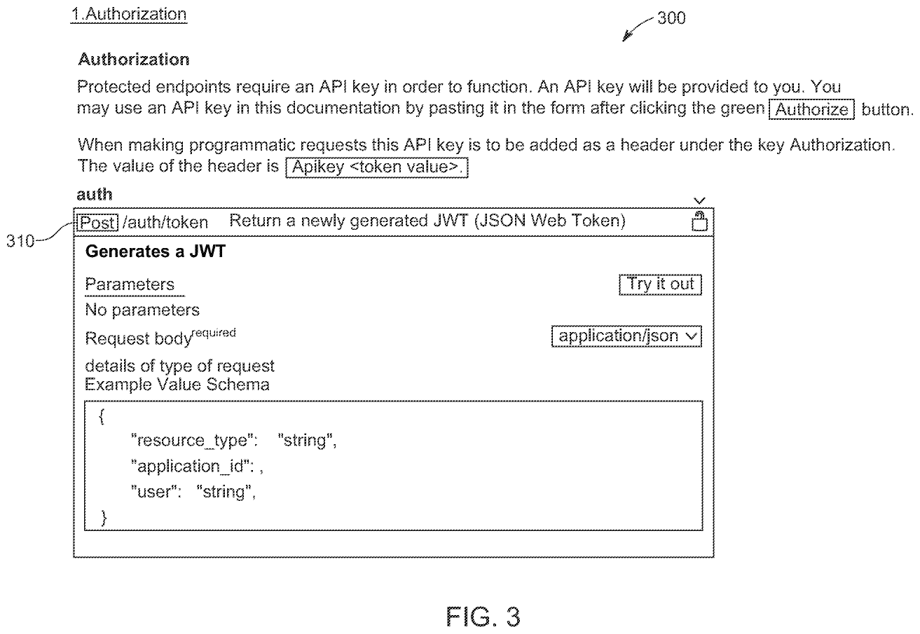

Reference is next made to FIGS. 3 to 6 which show in diagrammatic form exemplary forms or windows for accessing API endpoints in the API 120 to interface to the job screening system 10. As described above, the API 120 provides an interface for the organization 110 and the associated entities or customers 130 to access the job screening system 10 for analysis, processing and/or grading. According to an exemplary implementation, calls into each endpoint of the Application Programming Interface 120 comprise REST (Representational State Trainer) calls. According to another aspect, the objects for the endpoints in the API 120 comprise a company object(s), a job(s) object(s) and job application(s) object(s).

Reference is made to FIG. 3, which shows an exemplary implementation for generating an authorization token at the authentication endpoint 170 for the API 120 (FIG. 1) indicated generally by reference 300. The authorization token is generated utilizing a POST request or call, as indicated by reference 310, to generate a JSON Web Token or JWT as depicted in FIG. 3.

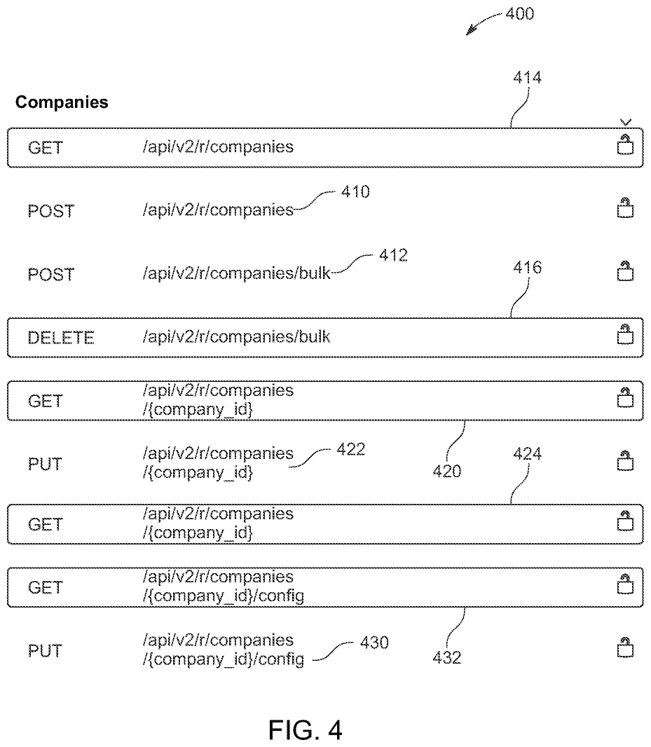

Reference is next made to FIG. 4, which shows an exemplary form for the Companies API endpoint 140 in the API 120, indicated generally by reference 400. According to an exemplary implementation, the Companies API endpoint 140 comprises a POST companies request or call indicated by reference 410, and POST companies bulk request or call indicated by reference 412. The POST companies request 410 to the Companies API endpoint 140 is utilized to create a company or customer entity record in the database 20 for the job screening system 10 corresponding to one of the entities 130 in the organization 110. The POST companies bulk request 412 is utilized to create multiple companies, e.g. customer or company records in the database 10, using a single request or call. As shown, the Companies API endpoint 140 is configured for a GET companies request or call 414, and a DELETE companies BULK request or call 416. The Companies endpoint 140 in the API 120 is configured to retrieve company data from the database 20 in the job screening system 10. The DELETE companies BULK request 416 allows multiple companies, e.g. multiple company records, to be deleted or removed from the database 20 in the job screening system 10. As shown, the Companies endpoint 140 for the API 120 is also configured to be responsive to GET, PUT and DELETE requests or calls based on a “company_id” parameter, indicated individually by references 420, 422 and 424, respectively. As shown in FIG. 4, the Companies endpoint 140 is also configured for a PUT “companies” CONFIG request or call 430 and a GET companies CONFIG request or call 432.

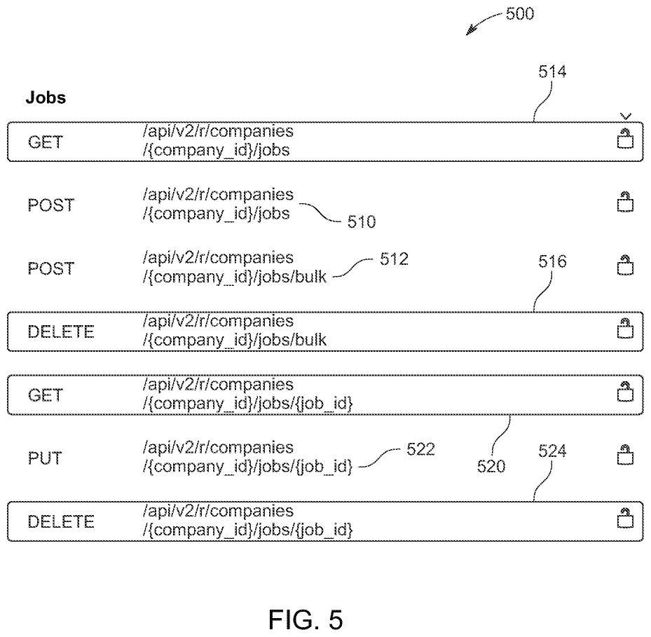

Reference is next made to FIG. 5, which shows an exemplary form or window for the Jobs API endpoint 150 in the API 120, indicated generally by reference 500. According to an exemplary implementation, the Jobs API endpoint 150 is configured for a POST jobs request or call indicated by reference 510, and a POST jobs BULK request or call indicated by reference 512 based on the “company_id” parameter. The POST jobs request 510 to the Jobs API endpoint 150 is configured to create a job for a company or customer entity record in the database 20 for the job screening system 10 corresponding to one of the entities 130 as identified or referenced by the “company_id” parameter. The POST jobs BULK request 512 is utilized to create multiple jobs or roles, e.g. job records for a company in the database 20, using the single request or call. As shown, the Companies API endpoint 140 is configured for a GET jobs request or call 514 and a DELETE jobs BULK request or call 516, for an entity, e.g. company or customer, identified or referenced by the “company_id” parameter. The Companies endpoint 140 in the API 120 is configured to retrieve company data from the database 20 in the job screening system 10. The DELETE jobs BULK request 516 allows multiple jobs or roles to be deleted or removed from the database 20 in the job screening system 10 for an entity, e.g. company or customer, identified or referenced by the “company_id” parameter. As shown, the Jobs endpoint 150 for the API 120 is also configured to be responsive to GET, PUT and DELETE requests or calls based on a “job_id” parameter for the entity, e.g. company or customer, identified by the “company_id” parameter, indicated individually by references 520, 522 and 524, respectively.

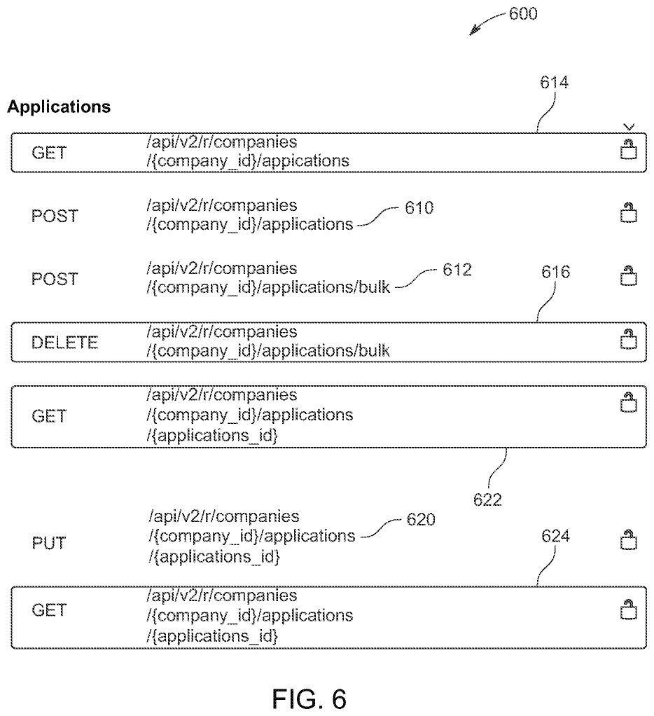

Reference is next made to FIG. 6, which shows an exemplary form for the Applications API endpoint 160 in the API 120, indicated generally by reference 500. According to an exemplary implementation, the Applications API endpoint 160 is configured for a POST applications request or call indicated by reference 610, and a POST applications BULK request or call indicated by reference 612 based on the “company_id” parameter. The POST applications request 610 to the Applications API endpoint 160 is configured to create an application for a job for a company or customer entity record in the database 20 for the job screening system 10 corresponding to one of the entities 130 as identified or referenced by the “company_id” parameter. The POST applications BULK request 612 is utilized to create multiple applications, e.g. application records for a company in the database 20, using the single request or call. As shown, the Applications API endpoint 160 is configured for a GET applications request or call 614 and a DELETE applications BULK request or call 616, for an entity, e.g. company or customer, identified or referenced by the “company_id” parameter. The Applications endpoint 160 in the API 120 is configured to retrieve application(s) data from the database 20 in the job screening system 10. The DELETE applications BULK request 616 allows multiple applications to be deleted or removed from the database 20 in the job screening system 10 for an entity, e.g. company or customer, identified or referenced by the “company_id” parameter. As shown, the Applications endpoint 160 for the API 120 is also configured to be responsive to GET, PUT and DELETE requests or calls based on a “application_id” parameter for the entity, e.g. company or customer, identified by the “company_id” parameter, indicated individually by references 620, 622 and 624, respectively.

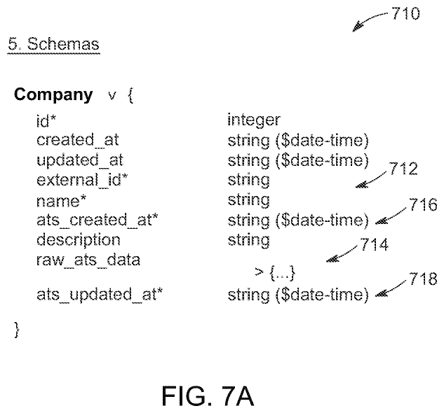

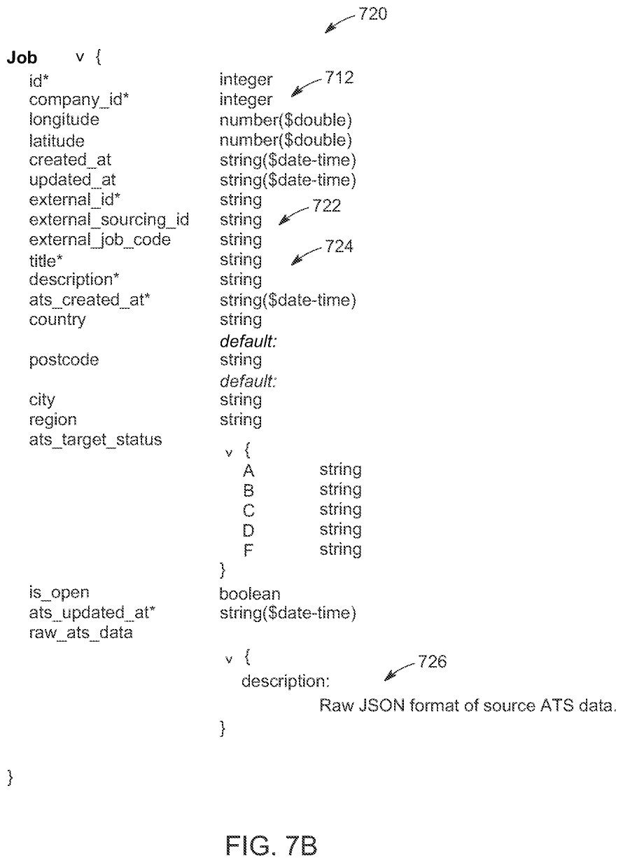

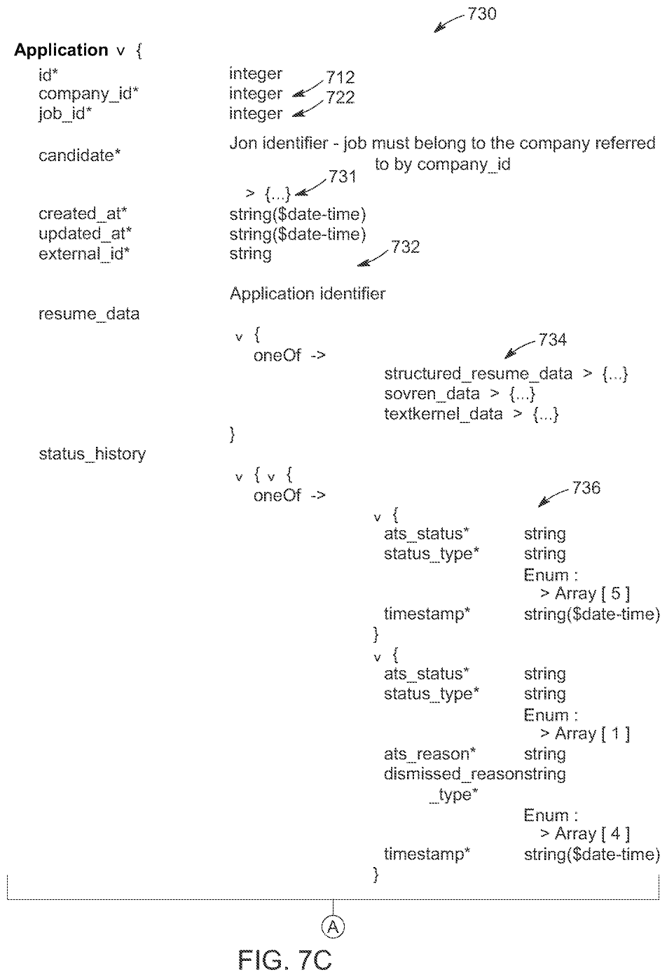

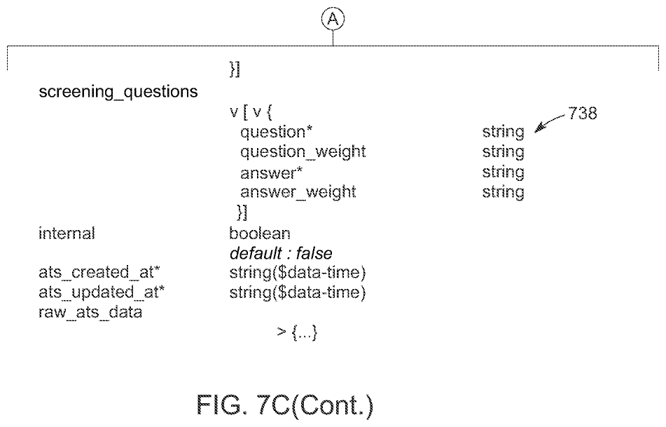

Reference is next made to FIG. 7A, which shows an exemplary schema, i.e. database structure, for a company record 22 (FIG. 1) stored in the database 10 (FIG. 1) and indicated generally by reference 710. According to an embodiment, the company record 710 comprises an internal “id”, and “external_id”, i.e. “company_id”, indicated by reference 712. The company schema 710 comprises a data field or element indicated by reference 714, which according to an exemplary embodiment is populated with data and information derived from an Applicant Tracking System or ATS as indicated. The company schema 710 includes further elements or fields such as “ats_created_at” field and “ats_updated_at” field indicated by references 716 and 718, respectively. The particular implementation details of the company schema will be within the understanding of one skilled in the art.

Reference is made to FIG. 7B, which shows an exemplary “Job” schema, i.e. database structure, for a job record 26 (FIG. 1) stored in the database 10 (FIG. 1) and indicated generally by reference 720. According to an embodiment, the job schema 720 comprises a “company id” field, “company_id”, indicated by reference 712 to identify the company associated with the job or role. The job schema 720 includes an “external id” field 722 for the “job_id” for identifying the associated job or role. The job schema 720 includes fields for further descriptive strings, such as, “external_job_code”, “title”, “description”, etc., as shown and indicated generally by reference 724. The Job schema 720 also includes a “raw_ats_data” field indicated by reference 726, which is populated with associated job data derived from or inputted from an ATS, e.g. raw JSON format ATS source data, as indicated by reference 726. The particular implementation details of the job schema will be within the understanding of one skilled in the art.

Reference is made to FIG. 7C, which shows an exemplary application schema or database structure for an application record 24 stored in the database 10 (FIG. 1) and indicated generally by reference 730. According to an embodiment, the application schema 730 includes the “company_id” indicated by reference 712 and the “job_id” indicated by reference 722 in FIG. 7C. The application schema 730 includes a “candidate” field indicated by reference 731 and an “external id” field 732 for the “application_id” for identifying the associated application. The application schema 730 includes a “resume_data” field indicated by reference 734 and configured for storing resume data and information for the applicant. The application schema 730 includes a “status_history” field indicated by reference 736 and configured for storing historical data and information for the applicant, such as dismissal data for example. The application schema 730 includes a “screening_questions” field indicated by reference 738 and is configured for storing information or data such as screening questions, answers, question weightings and answer weightings for the applicant. The particular implementation details of the application schema will be within the understanding of one skilled in the art.

Reference is made to FIG. 7D, which shows an exemplary error response schema, i.e. database structure, for an error message generated in accordance with an embodiment and indicated generally by reference 740. According to an exemplary embodiment, the error response schema 740 comprises a “message” field indicated by reference 742 for storing the string for the error message, and a “details” field indicated by reference 744 configured for providing details about the error message. The particular implementation details of the application schema will be within the understanding of one skilled in the art.

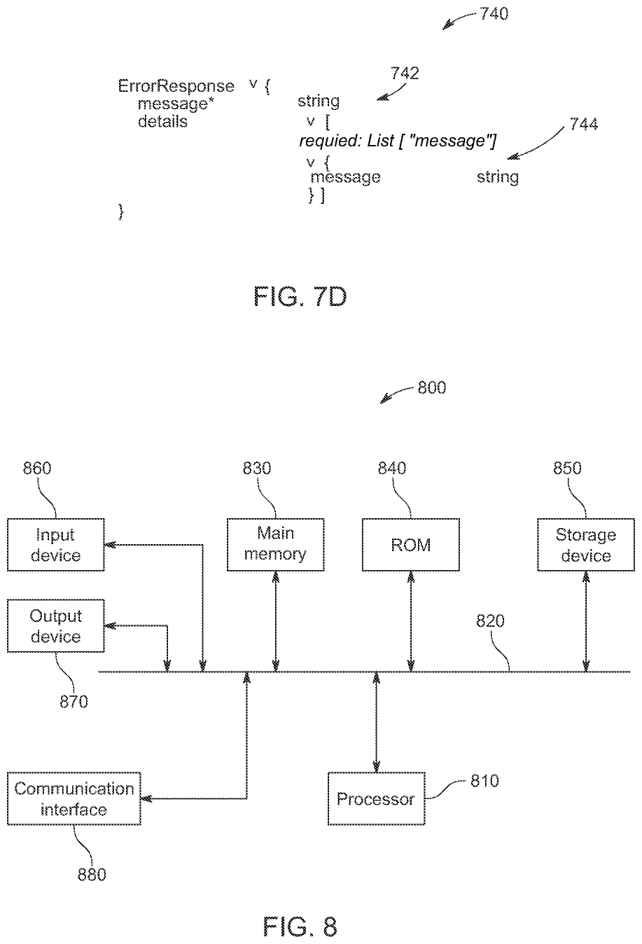

Reference is next made to FIG. 8, which shows an exemplary implementation for a client or server entity (i.e. a “client/server entity”), which may correspond to one or more of the servers (e.g. computers) comprising the backend system 10 (FIG. 1) and/or client machines or appliances (e.g. computers) 110 (FIG. 1), in accordance with the functionality and features of the embodiments as described in more detail below. The client/server entity is indicated generally by reference 800 and comprises a processor (e.g. a central processing unit or CPU) 810, a bus 820, a main memory 830, a read only memory or ROM 840, a mass storage device 850, an input device 860, an output device 870, and a communication interface 880. The bus 820 comprises a configuration (e.g. communication paths or channels) that permits communication among the elements or components comprising the client/server entity 800.

The processor 810 may comprise a hardware-based processor, microprocessor, or processing logic that is configured, e.g. programmed, to interpret and/or execute instructions. The main memory 830 may comprise a random-access memory (RAM) or other type of dynamic storage device that is configured to store information and/or instructions for execution by the processor 810. The read only memory (ROM) may comprise a conventional ROM device or another type of static or non-volatile storage device configured to store static information and/or instructions for user by the processor 810. The storage device 850 may comprise a disk drive, solid state memory or other mass storage device such an optical recording medium and its corresponding drive or controller, configured for the database 20.

The input device 860 may comprise a device or mechanism configured to permit an operator or user to input information to the client/server entity, such as a keyboard, a mouse, a touchpad, voice recognition and/or biometric mechanisms, and the like. The output device 870 may comprise a device or mechanism that outputs information to the user or operator, including a display, a printer, a speaker, etc. The communication interface 880 may comprise a transceiver device or mechanism, and the like, configured to enable the client/server entity 800 to communicate with other devices and/or systems. For instance, the communication interface 880 may comprise mechanisms or devices for communicating with another machine, appliance or system via a network, for example, the Internet (FIG. 1).

As described, in accordance with embodiments according to the present invention, the client/server entity 800 may be configured to perform operations or functions relating to the process of selecting a suitable candidate, to the process of generating a candidate model or template, and the other functions as described or depicted herein. The client/server 800 may be configured to perform these operations and/or functions in response to the processor 810 executing software instructions or computer code contained in a machine or computer-readable medium, such as the memory 830. The computer-readable medium may comprise a physical or a logical memory device or medium.

The software instructions or computer code may be read into the memory 830 from another computer-readable medium, such as a data storage device 850, or from another device or machine via the communication interface 880. The software instructions or computer code contained or stored in the memory 830 instruct, or cause, the processor 810 to perform or execute processes and/or functions as described in more detail herein. In the alternative, hardwired circuitry, logic arrays, and the like, may be used in place of or in combination with software instructions to implement the processes and/or functions in accordance with the embodiments of the present invention. Therefore, implementations consistent with the principles of the embodiments according to the present invention are not limited to any specific combination of hardware and/or software.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A software module configured for providing an interface to a job screening system, said job screening system including a server configured with a database and a machine learning engine configured for screening one or more applications for a job or position at a company, said software module comprising:
a software component configured for updating data associated with the company, said database comprising a record for the company and including one or more data fields for storing said associated company data;
a software component configured for updating data associated with the job, said database comprising a record for the job and including one or more data fields for storing said associated job data;
a software component configured for updating data associated with the one or more applications, said database comprising a record for each of the one or more applications and including one or more data fields for storing said associated application data;
the machine learning engine comprising a processor component configured to screen the application based on said application record and based on said screening process generate a score for the application; and
said applications software component being configured to make available said generated score to the company.

2. The software module as claimed in claim 1, wherein the database is configured to store a plurality of company records, and each of said plurality of company records being configured as an independent data structure in the database, and wherein each of said plurality of company records comprise a hierarchical structure, said hierarchical structure comprising a link to said job record associated with the company, and comprising a link to said application record associated with the job, and said application record further including a link to said company record.

3. The software module as claimed in claim 2, wherein said company record comprises a company object, and said job record comprises one or more job objects, and said one or more job objects being linked to the company, and said application record comprises an application record, said application object being linked to said job object and to said company object.

4. The software module as claimed in claim 2, wherein said score comprises a report card and said report card being configured as a JSON record, said JSON record comprising one or more of an application grade, one or more associated skills, a job history and applicant data.

5. The software module as claimed in claim 1, wherein said company software component is configured to create a plurality of companies comprising a company record configured in the database for each of said plurality of companies, wherein each of said plurality of companies is associated with a partner organization.

6. The software module as claimed in claim 5, further including a software component configured for generating one or more authentication credentials for providing independent access to the job screening system for each of said plurality of companies.

7. The software module as claimed in claim 6, wherein said company software component is configured to create said plurality of companies as a single integration the partner organization level.

8. The software module as claimed in claim 7, wherein each of said company records comprise a hierarchical structure, said hierarchical structure comprising a link to said job record associated with the company, and comprising a link to said application record associated with the job, and said application record further including a link to said company record.

9. The software module as claimed in claim 8, further configured as an application programming interface (API), said software component configured for updating data associated with the company comprising an endpoint configured for accessing said API and said associated company records in the database of the job screening system, said software component configured for updating data associated with the job comprising an endpoint configured for accessing said API and said associated job records in the database of the job screening system, and said software component configured for updating data associated with the application comprising an endpoint configured for accessing said API and said associated application records in the database of the job screening system.

10. A computer-implemented process for accessing a job screening system through an application programming interface (API), said computer-implemented process comprising the steps of:
submitting an application for a candidate for grading through an application endpoint to the API for the job screening system;
screening the application at the job screening system utilizing a machine learning model and generating a grade for the application;
updating an application record for the candidate in a database for the job screening system; and
providing said grade through said application endpoint to the API.

11. The computer-implemented process as claimed in claim 10, further including the steps of,
creating one or more jobs through a jobs application endpoint to the API for the job screening system;
creating a job record for each of said one or more jobs in the database for the job screening system;
performing an auto-bucketing process for grouping said one or more jobs; and
updating said job records in the database for the job screening system.

12. The computer-implemented process as claimed in claim 11, further including the step of updating a company record in the database for the job screening system, said company record comprising a hierarchical structure and comprising a link to said job record associated with the company record, and comprising a link to said application record, and said application record comprising a link to said company record.

13. A computer program product for providing an interface to a job screening system, said job screening system including a server configured with a database and a machine learning engine configured for screening one or more applications for a job or position at a company, said computer program product comprising:
a non-transitory storage medium configured to store computer readable instructions;
said computer readable instructions including instructions for,
updating data associated with the company through a company endpoint to an application programming interface (API), said database comprising a record for the company and including one or more data fields for storing said associated company data;
updating data associated with the job through a job endpoint to an API, said database comprising a record for the job and including one or more data fields for storing said associated job data;
updating data associated with the one or more applications through an applications endpoint to the API, said database comprising a record for each of the one or more applications and including one or more data fields for storing said associated application data; and
screening the application utilizing a machine learning engine in the job screening system and generating a grade for the application.

14. The computer program product as claimed in claim 13, wherein the database is configured to store a plurality of company records, and each of said plurality of company records being configured as an independent data structure in the database, and wherein each of said plurality of company records comprise a hierarchical structure, said hierarchical structure comprising a link to said job record associated with the company, and comprising a link to said application record associated with the job, and said application record further including a link to said company record.

15. The computer program product as claimed in claim 14, wherein said company record comprises a company object, and said job record comprises one or more job objects, and said one or more job objects being linked to the company, and said application record comprises an application record, said application object being linked to said job object and to said company object.

16. The computer program product as claimed in claim 15, wherein said score comprises a report card and said report card being configured as a JSON record, said JSON record comprising one or more of an application grade, one or more associated skills, a job history and applicant data.
